(19) United States
(12) Patent Application Publication
(10) Pub. No.: US 2018/0184631 A1
(43) Pub. Date: Jul. 5, 2018

(54) FISHING TOOL SINKING ROPE AND MODULAR SNAP FASTENER OF USING THE SAME

(71) Applicant: HSIEH FOU FISHING TACKLES INDUSTRY CO.,LTD., Kaohsiung City (TW)

(72) Inventors: Jui-Wen YEH, Kaohsiung City (TW); Yu-Hao YEH, Kaohsiung City (TW)

(21) Appl. No.: 15/759,373

(22) PCT Filed: Sep. 14, 2015
(86) PCT No.: PCT/CN2015/089513

§ 371 Date: Mar. 12, 2018

(51) Int. Cl. A01K 75/06

(52) U.S. Cl. CPC A01K 75/06

(57) ABSTRACT

A fishing tool sinking rope and modular snap fastener. A module stringing core strings a plurality of sinking elements at equal intervals. Each sinking element has a main body with two ends connected to a neck portion and terminal portion. The neck portion has a radial cross-sectional size less than that of the main body and terminal portion. A covering woven rope is interlaced to cover the module stringing core. The modular snap fastener has a bendable line and plurality of droplet-shaped hollow snap fastening members connected to two ends of the bendable line. Each hollow snap fastening member has a U-shaped gap snap fastening slot configured to fit the neck portion. The sinking element and modular snap fastener can be quickly assembled to form a string of the module stringing core serving as a center line of circular knitting machine to produce the fishing tool sinking rope.

### BACKGROUND OF THE INVENTION

### 1. Field of the Invention

The present invention relates to a fishing tool, and more particularly to a fishing tool sinking rope and modular snap fastener of using the same.

### 2. Description of the Related Art

A sinking rope for conventional fishing net is composed of counterweight lead sinkers. A core line is covered inside a plurality of counterweight lead sinkers, so that a plurality of lead sinkers can string together by means of the same core line to form a continuous chain. When in use, the sinking rope is knotted on the lower net rope, so when casting the fishing net, through sinking counterweight of sinking heavy rope and floats on the upper net rope, the lower net rope is automatically pulled downward and the fishing net can be cast vertically, so that the goal of quickly casting a fishing net can be achieved.

Please refer to Taiwan Utility Model Patent Publication No. M256071, “Improving Structure of Fishing Net”, which comprises a net main body, a floating rope set and a counterweight rope set. The floating rope set combines a plurality of upper wearing gears configured on the net main body, and the counterweight rope set combines a plurality of lower wearing gears configured on the net main body. The lead rope set includes a net rope and a woven net rope, and a plurality of counterweight bodies are covered inside the woven net rope at intervals and in sections. Between two adjacent counterweight bodies, the woven net rope is knotted with the net rope, so that it can prevent the lead rope set from improper entanglement during casting or dragging operation.

Please refer to Taiwan Utility Model Patent Publication No. M454089, “Improved Structure of Weight Rope Used in Fishing Net”, which comprises a hollow net rope, a first counterweight chain and a second counterweight chain. The first and the second counterweight chain are disposed inside the hollow net rope. Each counterweight chain comprises a plurality of counterweight block lined at equal intervals. The interval between the first and the second counterweight chains is not less than the first interval of the first counterweight block, so that the hollow net rope can include a stringing section with natural narrow tube diameter. Therefore, the goal that multiple-segment counterweight chains can be naturally fixed and the function of automated stringing on the lower rope can be obtained. The counterweight chain is strung by a plurality of counterweight blocks which will limit its volume and size, so the intervals between counterweight blocks cannot be adjusted and controlled, and the counterweight blocks also easily separate from the lead rope.

### SUMMARY OF EMBODIMENTS OF THE INVENTION

Therefore, an objective of an embodiment of the present invention is to provide a fishing tool sinking rope and modular snap fastener of using the same. Through the quickly connector, the sinking element and the modular snap fastener can be quickly assembled to form a string of the module stringing core serving as a center line of circular knitting machine to produce the fishing tool sinking rope, so that the automated production of covering the sinking elements at equal intervals can be achieved during the weaving process of the covering rope.

Another objective of an embodiment of the present invention is to provide a fishing tool sinking rope and modular snap fastener of using the same, by which a plurality of sinking elements can be automatically covered insides the sinking rope at equal intervals. Therefore, a conventional circular knitting machine can be used to produce the fishing tool sinking rope, and the intervals between sinking elements can be adjusted and controlled by determined modular snap fastener, so it is not necessary to string the sinking elements to form a chain, and the main body of the sinking elements can have variation in volume, size and interval. When the fishing tool sinking rope is cast under the sea, it will have twilight effect and will not easily entangle with net to cause separation.

The object and solution is achieved by the method depicted below. A fishing tool sinking rope is disclosed by the present invention, comprising a module stringing core and a covering woven rope. The module stringing core is configured to string a plurality of sinking elements at equal intervals. Each of the sinking elements comprises a main body having two ends connected jointly to a neck portion and a terminal portion. The neck portion has a radial cross-sectional size less than a radial cross-sectional size of the main body and a radial cross-sectional size of the terminal portion. The module stringing core further comprises a plurality of modular snap fasteners. Each modular snap fastener includes a bendable line and a plurality of droplet-shaped hollow snap fastening members connected to two ends of the bendable line for housing a plurality of terminal portions. Each of the hollow snap fastening members is comparatively distant from the center of corresponding modular snap fasteners and has a U-shaped gap snap fastening slot configured to fit the neck portion. The covering woven rope is interlaced to cover the module stringing core. A modular snap fastener used in the fishing tool sinking rope is disclosed by the present invention.

The object and solution can be further achieved by the method depicted below.

In the aforementioned fishing tool sinking rope, the hollow snap fastening member is semi-covered, and protrusions on the two sides of the U-shaped gap snap fastening slot are flexible for clamping, so that the U-shaped gap snap fastening slot can easily fit the corresponding neck portion.

In the aforementioned fishing tool sinking rope, the shape of the terminal portion can be spherical, so when the sinking element rotates, the terminal portion will not separate from the corresponding hollow snap fastening member.

In the aforementioned fishing tool sinking rope, the radial cross-sectional size of the terminal portion is particularly less than the radial cross-sectional size of the main body, so that the radial cross-sectional size of hollow snap fastening members will not protrude over the radial cross-sectional size of the main body. Therefore, the terminal portion will not easily separate from the hollow snap fastening member.

In the aforementioned fishing tool sinking rope, preferably, the cross section of the hollow snap fastening members is semi-cut and is a tapered edge leaning toward the opening of the U-shaped gap snap fastening slot for helping the U-shaped gap snap fastening slot fit the corresponding neck portion.

In the aforementioned fishing tool sinking rope, the shape of the main body can be cylindrical, so that the sinking elements can have a better volume for operation, and when the sinking elements rotate, it will not damage the covering woven rope.

In the aforementioned fishing tool sinking rope, the shape of the main body can be oval, so that the sinking elements can help covering woven rope for its covering operation.

In the aforementioned fishing tool sinking rope, at least a plurality of main bodies can be a counterweight chain to adjust the counterweight section of sinking rope.

According to the aforementioned methods, an advantage of an embodiment of the invention is that through a creative combination of module stringing core, the sinking element and the modular snap fastener can be quickly assembled by the quickly connector to form a string of the module stringing core serving as a center line of circular knitting machine and produce the fishing tool sinking rope. Therefore, the automated production of covering the sinking elements at equal intervals can be achieved during the weaving process of the covering rope. Besides, a plurality of sinking elements can be automatically covered insides the sinking rope at equal intervals.

### BRIEF DESCRIPTION OF THE DRAWINGS

FIG. 1 is a partial exploded view of a fishing tool sinking rope in a first preferred embodiment according to the present invention;

FIG. 2 is a partial exploded view of the module stringing core in the first preferred embodiment;

FIG. 3A to 3C are exploded view, cross-sectional side view and front view of the sinking elements in the first preferred embodiment;

FIG. 4A to 4D are exploded view, cross-sectional side view, front view and bottom view of the modular snap fastener in the first preferred embodiment;

FIG. 5 is a drawing depicting that a fishing tool sinking rope assembles a fishing net in the first preferred embodiment;

FIG. 6 is a partial exploded view of a fishing tool sinking rope in a second preferred embodiment according to the present invention;

FIG. 7 is a partial exploded view of the module stringing core in the second preferred embodiment;

FIG. 8A to 8C are exploded view, cross-sectional side view and front view of the sinking element in the second preferred embodiment;

FIG. 9A to 9C are exploded view, cross-sectional side view and front view of the sinking element in a third preferred embodiment according to the present invention;

FIG. 10A to 10C are exploded view, cross-sectional side view and front view of the sinking element in a fourth preferred embodiment according to the present invention; and

FIG. 11 is a partial exploded view depicting that another fishing tool sinking rope axially cuts the covering woven rope in a fifth preferred embodiment according to the present invention.

### REFERENCE NUMERALS

D1 a radial cross-sectional size of the main body;

D2 a radial cross-sectional size of the neck portion;

D3 a radial cross-sectional size of the terminal portion; fishing net; 11 net lines; 12 upper net rope; 12A upper net rope stringing areas; 13 lower net rope; 13A lower net rope stringing areas; 20 fishing tool sinking rope; 100 fishing tool sinking rope; 110 module stringing core; 120 covering woven rope; 130 sinking elements; 131 main body; 132 neck portion; 133 terminal portion; 140 modular snap fastener; 141 bendable line; 142 hollow snap fastening member 143 U-shaped gap snap fastening slot 144 protrusions; 145 tapered edge; 200 fishing tool sinking rope; 230 sinking elements; 231 main body; 330 sinking elements; 333 terminal portion; 334 faceted edges; 335 convergent curved surface; 430 sinking elements; 431 main body; 433 terminal portion; 434 faceted edges; 435 convergent tapered surface; 500 fishing tool sinking rope; 510 module stringing core; 530 sinking elements; 531 main body.

### DETAILED DESCRIPTION OF THE PREFERRED EMBODIMENTS

Specific structural and functional details disclosed herein will become apparent from the following description of the preferred embodiment of the present invention taken in conjunction with the accompanying drawings, which provides better an understanding to a person having ordinary skill in the art but shall not be construed as limiting the invention.

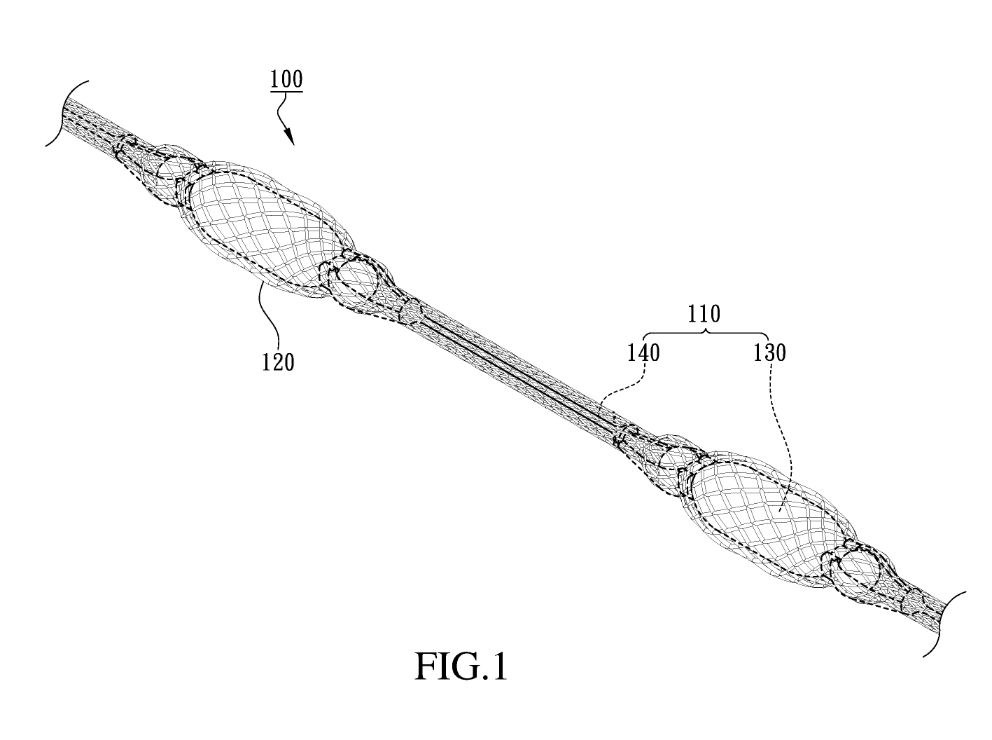

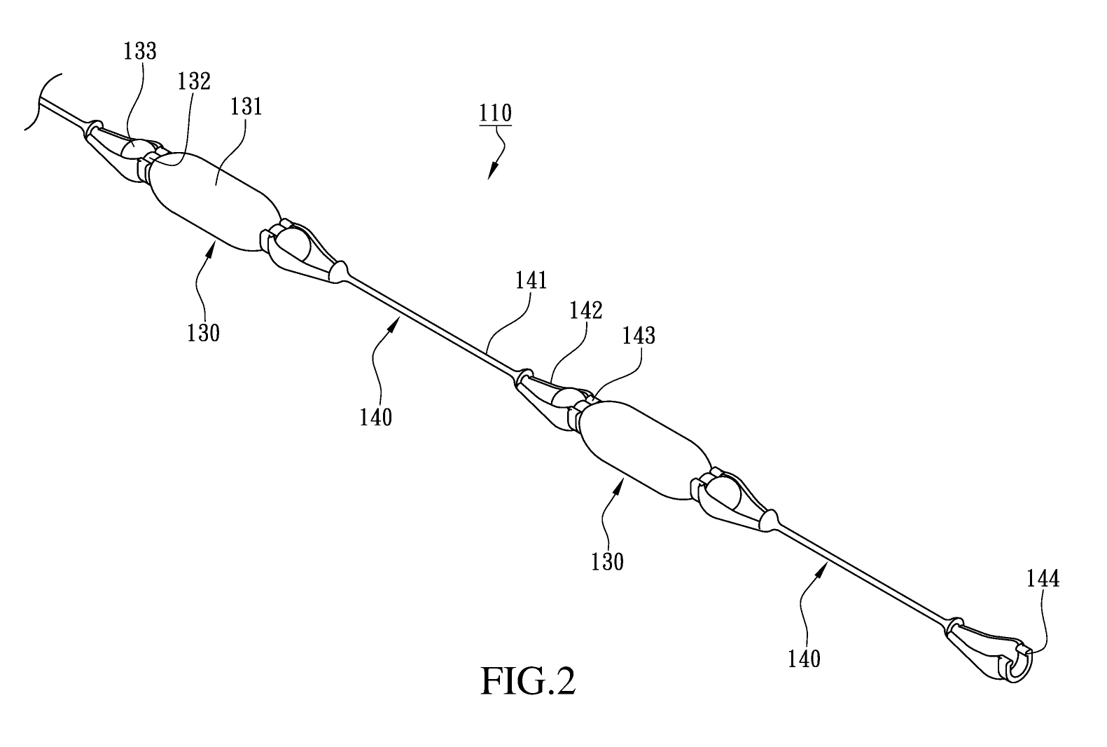

With reference to FIG. 1, a partial exploded view of a fishing tool sinking rope 100 in the first preferred embodiment according to the present invention. A fishing tool sinking rope 100 comprises a module stringing core 110 and a covering woven rope 120. The covering woven rope 120 is interlaced to cover the module stringing core 110. With reference to FIG. 2, a partial exploded view of the module stringing core 110 is depicted.

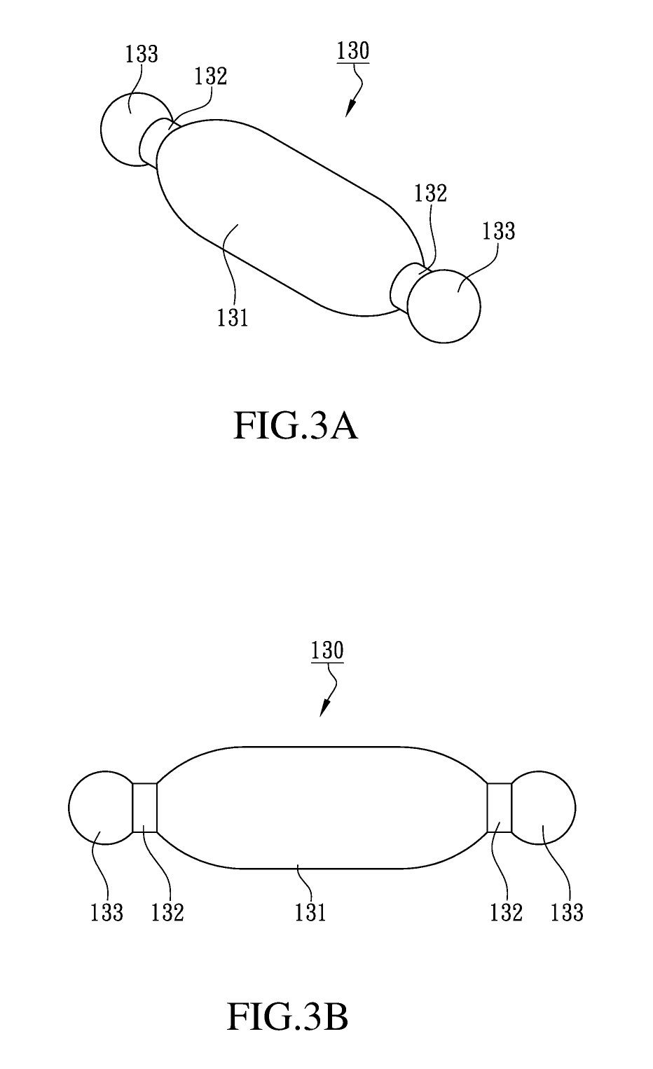

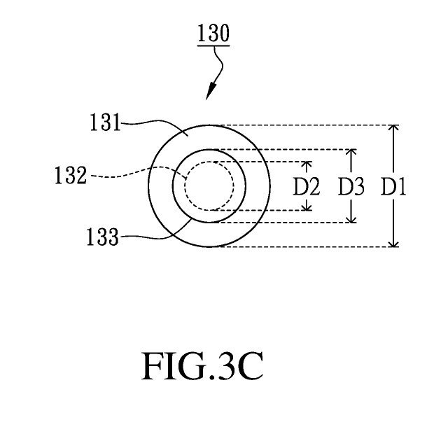

With reference to FIG. 2, the module stringing core 110 is configured to string a plurality of sinking elements 130 at equal intervals. With reference to FIGS. 3A, 3B and 3C, exploded view, cross-sectional side view and front view of the sinking elements 130 are depicted. Each of the sinking elements 130 has a main body 131 having two ends connected jointly to a neck portion 132 and a terminal portion 133. The neck portion 132 has a radial cross-sectional size D2 less than radial cross-sectional size D1 of the main body and radial cross-sectional size D3 of the terminal portion 133 (shown in the FIG. 3C). By different radial cross-sectional size, the rotation of the sinking element 130 in the covering woven rope 120 can be reduced. The axial direction means the direction between two terminal portions 133 on the same sinking element 130, and the radial direction means the direction or panel parallel to the axial direction. The radial cross-sectional size named herein means that the largest size is obtained based on an object parallel to the axial direction. Different radial cross-sectional sizes of the sinking elements 130 are shown in the FIG. 3C, the front view of the sinking elements. Furthermore, the module stringing core 110 is a bendable strung object used for rolling and storing. The length of module stringing core 110 is adjustable on demand to meet the requirement of different fishing tool sinking rope. The sinking element 130 can be made from sinking objects which have density larger than water or seawater, so that it can sink into the water. The material of sinking element 130 can be lead, lead-tin compounds or metals with relatively high densities. The unit length of main body 131 can be larger than the unit lengths of the neck portion 132 and the terminal portion 133. With reference to FIGS. 3A and 3B, the shape of main body 131 is cylindrical, so that the sinking element 130 can have a better volume for operation, and when the sinking element 130 rotates, it will not damage the covering woven rope 120.

With reference to FIG. 1, the covering woven rope 120 can cover the sinking elements 130 at equal intervals. The covering woven rope 120 can be made from water-proof plastics, and can be interlaced with multiple strands by the circular knitting machine. The way that the covering woven rope 120 covers the module stringing core 110 is interlacing. The so called “interlacing” means that the module stringing cores 110 string together to be the core line of the covering woven rope 120. The multiple thin strands are interlaced around the module stringing core 110 to produce the covering woven rope 120, so that the sinking elements 130 can have a better covering and automated knitting operation. The definition of “interlacing” doesn't include the operation which is like to produce the covering woven rope 120 first which is plugged into the module stringing core 110 (or the sinking elements 130) later.

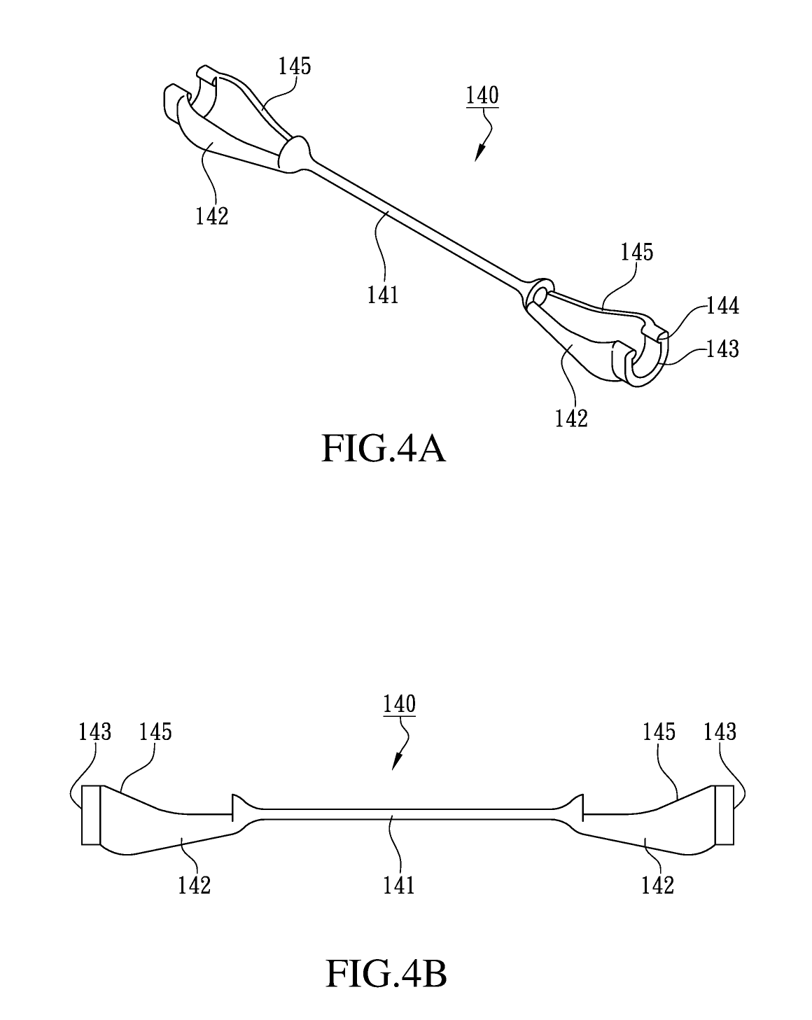

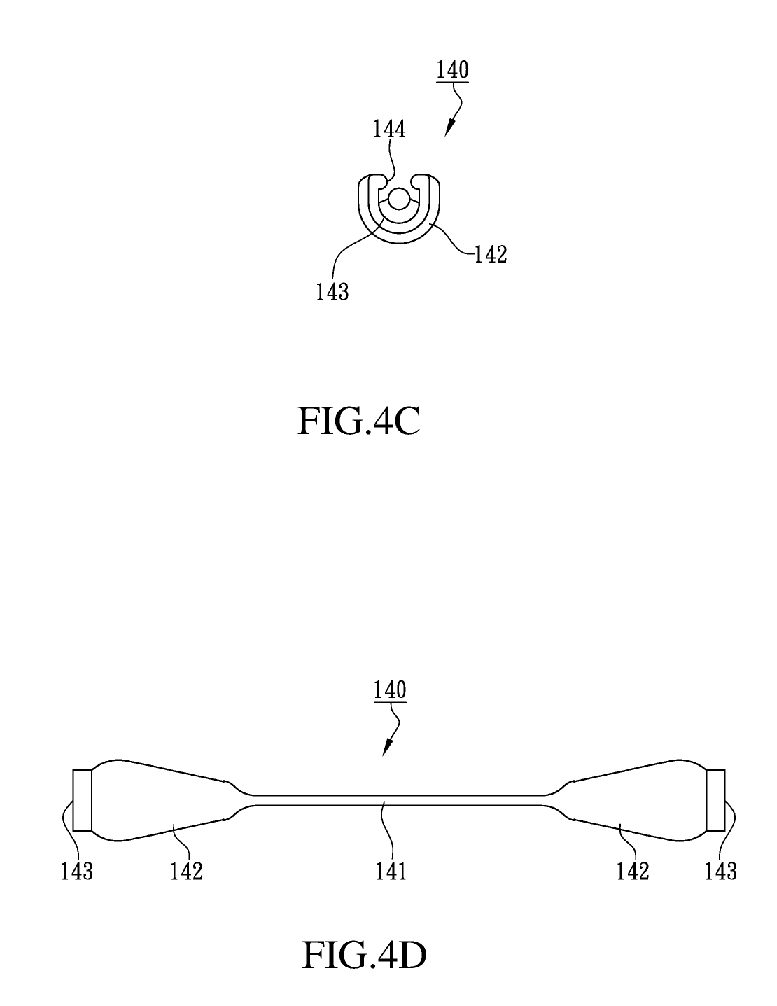

With reference to FIG. 2, in this preferred embodiment, the module stringing core 110 further comprises a plurality of modular snap fastener 140. With reference to 4A, 4B, 4C and 4D, exploded view, cross-sectional side view, front view and bottom view of the module stringing core 140 are depicted. Each modular snap fastener 140 comprises a bendable line 141 and a plurality of hollow snap fastening members 142 connected to two ends of the bendable line 141 for housing the terminal portions 133. The shape of the hollow snap fastening members 142 is droplet-shaped., and please refer to FIG. 4. Besides, each of the hollow snap fastening members 142 is comparatively distant from the center of corresponding modular snap fasteners 140 and has a U-shaped gap snap fastening slot 143 configured to fit the neck portion 132, so the sinking elements 130 can string at equal intervals. The bendable line 141 can bend following with the movement of covering woven rope 120 to maintain the intervals between the sinking elements 130. The modular snap fastener 140 can be made from water-proof plastics. The extension force of the bendable line 141 is larger than the weaving extension of the covering woven rope 120. The shape of the hollow snap fastening members 142 can house and fit the terminal portion 133. The cross-section size of the U-shaped gap snap fastening slot 143 can be less than the radial cross-section size D1 of the main body 131 and the radial cross-section size D3 of the terminal portion 133, so the U-shaped gap snap fastening slot 143 can fit the neck portion 132. With reference to FIG. 2, depending on the determined modular snap fastener 140, the unit length of the bendable line body 141 is larger than the unit length of the sinking element 130, and it can also equal to or less than the unit length of the sinking element 130, so that the equal intervals between the sinking elements 130 can be controlled.

With reference to FIG. 4A to 4C, the hollow snap fastening members 142 is semi-covered, so it can have flexible protrusions 144 on the two sides of the U-shaped gap snap fastening slot 143 for clamping, and the U-shaped gap snap fastening slot 143 can easily fit the corresponding neck portion 132. The two opposite protrusions 144 is less than the radial cross-section size of the neck portion 132. The protrusions 144 can help the modular snap fastener 140 fit the neck portion 132. The semi-covered hollow snap fastening members 142 helps the modular snap fastener 140 combine with or separate from the sinking element 130. Preferably, the cross section of the hollow snap fastening members 142 is semi-cut and is a tapered edge 145 (shown in FIG. 4B) leaning toward the opening of the U-shaped gap snap fastening slot 143 for helping the U-shaped gap snap fastening slot 143 fit the corresponding neck portion 132 in axial direction, which will larger than the force that the U-shaped gap snap fastening slot 143 presses on the neck portion 132 in radius. Therefore, it is easy to fasten the module and the module will not break easily.

With reference to FIGS. 3A and 3B, preferably, the shape of the terminal portion 133 is spherical, so when the sinking element 130 rotates, the terminal portion 133 will not separate from the corresponding hollow snap fastening member 142, and it can reduce the damage of the covering woven rope 120. With reference to FIG. 3C, the radial cross-section size D3 of terminal portion 133 is less than the radial cross-section size D1 of main body 131, so that the radial cross-section size of the hollow snap fastening members 142 will not protrude over the the radial cross-section size D1 of the main body 131. Therefore, the terminal portion 133 will not easily separate from the hollow snap fastening member 142.

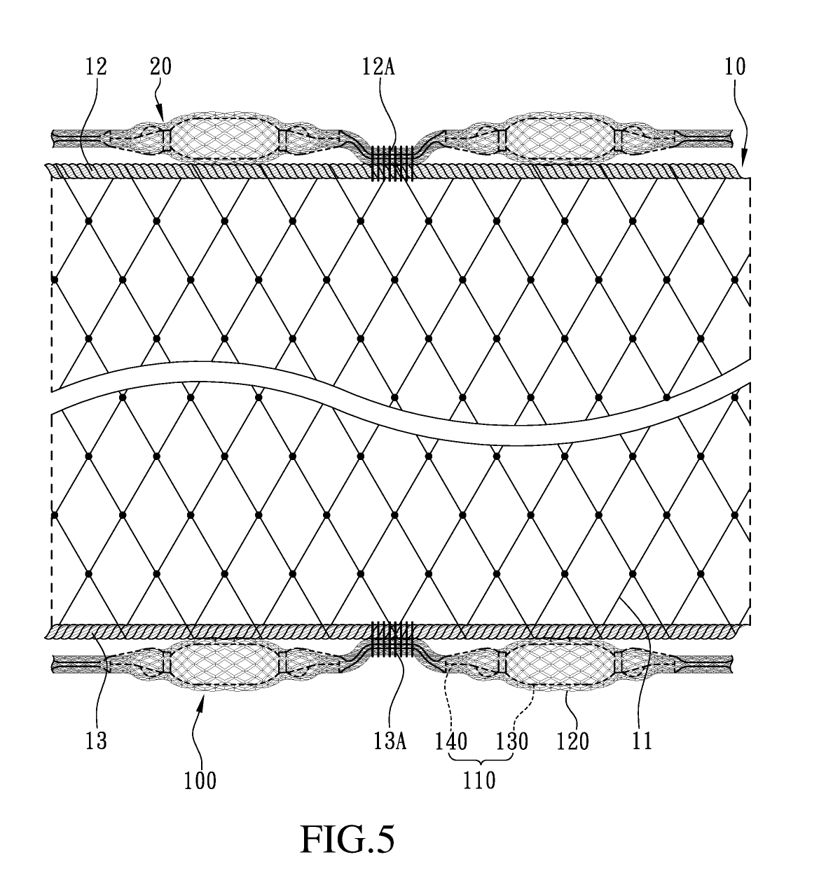

With reference to FIG. 5, a drawing depicting that a fishing tool sinking rope 100 assembles a fishing net. The fishing net 10 comprise a net body composed of a plurality of net lines 11, an upper net rope 12 and a lower net rope 13, wherein the upper net rope 12 is positioned on the upper edge of the net body, and the lower net rope 13 is positioned on the lower edge of the net body. A fishing tool sinking rope 20 is combined with the upper net rope 12 by a plurality of upper net rope stringing areas 12A. The fishing tool sinking rope 100 is combined with the lower net rope 13 by a plurality of lower net rope stringing areas 13A. When the fishing net is cast on the ocean, the net body composed of a plurality of net lines 11 will be extended. While drawing back the fishing net 10, the fishing tool sinking rope 100 will not entangle with the net lines 11. The section where the fishing tool sinking rope 100 is provided with a plurality of sinking elements 130 is in a high counterweight status, while the section where the fishing tool sinking rope 100 is provided with a plurality of modular snap fastener 140 is in a low counterweight status. When water flowing or the net is dragged, the section where the fishing tool sinking rope 100 is provided with a plurality of modular snap fastener 140 can be a buffer area to undulatingly disperse different stress, and the fishing net 10 will not move obviously. Therefore, when the fishing tool sinking rope is cast under the sea, it will have twilight effect and will not easily entangle with net to cause separation.

Therefore, a fishing tool sinking rope is disclosed by the present invention. Through a creative combination of module stringing core, the sinking element 130 and the modular snap fastener 140 can be quickly assembled by the quickly connector to form a string of the module stringing core 110 serving as a center line of circular knitting machine to produce the fishing tool sinking rope 100, so that the automated production of covering the sinking elements at equal intervals can be achieved during the weaving process of the covering rope. Besides, a plurality of sinking elements 13 can be automatically covered insides the sinking rope 100 at equal intervals. Therefore, a conventional circular knitting machine can be used to produce the fishing tool sinking rope, and the intervals between sinking elements 130 can be adjusted and controlled by determined modular snap fastener, so it is not necessary to string the sinking elements 130 to form a chain, and the main body of the sinking elements can have variation in volume, size and interval.

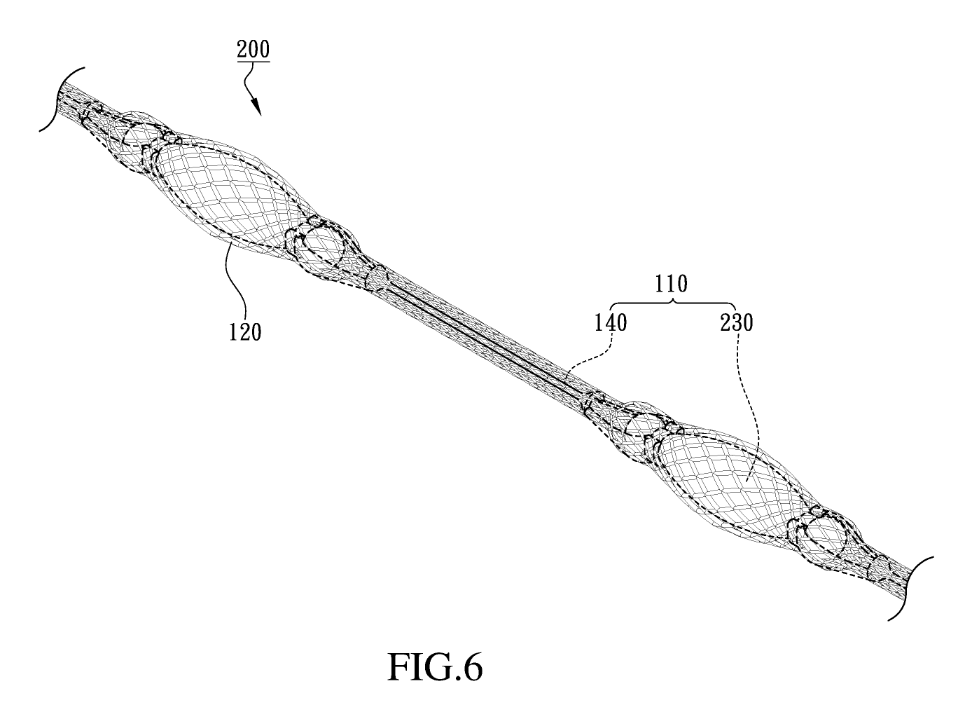

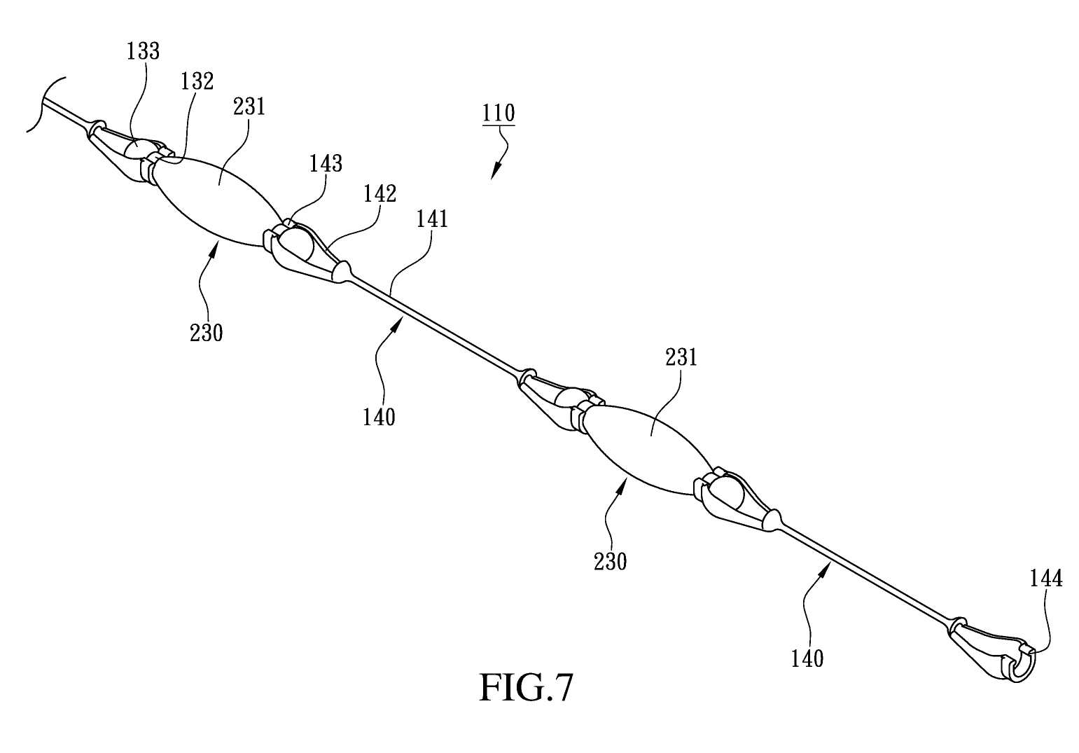

With reference to FIG. 6, a partial exploded view of a fishing tool sinking rope 200 in a second preferred embodiment of the present invention is depicted. Elements with the same name and function corresponding to the one in the first preferred embodiment are labeled with the same reference numbers, and so common features are not described again. A fishing tool sinking rope 200 comprises a module stringing core 110 and a covering woven rope 120. The covering woven rope 120 is interlaced to cover the module stringing core 110. With reference to FIG. 7, a partial exploded view of the module stringing core 110 is depicted.

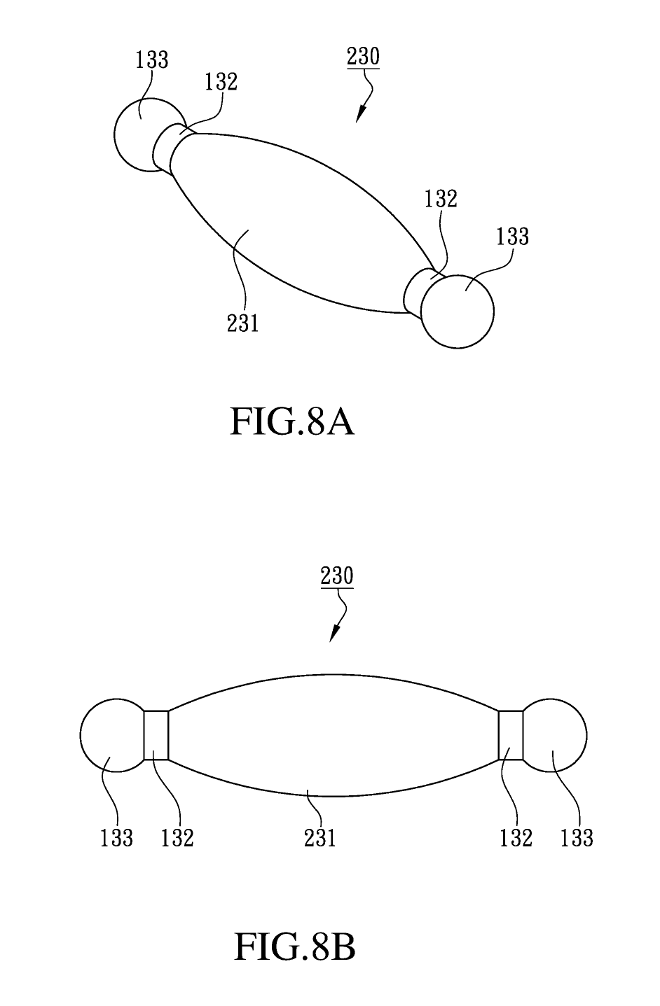

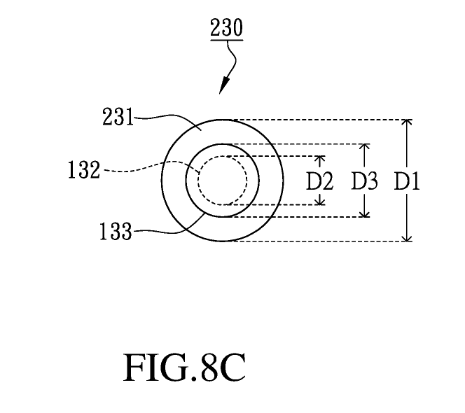

With reference to FIG. 7, the module stringing core 110 is configured to string a plurality of sinking elements 230 at equal intervals. With reference to FIGS. 8A, 8B and 8C, exploded view, cross-sectional side view and front view of the sinking elements 130 are depicted. Each of the sinking elements 230 has a main body 231 having two ends connected jointly to a neck portion 132 and a terminal portion 133. The neck portion 132 has a radial cross-sectional size D2 less than radial cross-sectional size D1 of the main body 231 and radial cross-sectional size D3 of the terminal portion 133 (shown in the FIG. 8C). The sinking element 230 can be made from sinking objects which have density larger than water or seawater, so that it can sink into the water. With reference to FIGS. 8A and 8B, the shape of the main body 231 can be oval, so that the sinking elements 230 can help covering woven rope 120 for its covering operation.

With reference to FIG. 7, in this preferred embodiment, the module stringing core 110 preferably further comprises a plurality of modular snap fasteners 140, and each modular snap fastener 140 comprises a bendable line 141 and a plurality of hollow snap fastening members 142 connected to two ends of the bendable line 141 for housing the terminal portions 133. Each of the hollow snap fastening members 142 is comparatively distant from the center of corresponding modular snap fasteners 140 and has a U-shaped gap snap fastening slot 143 configured to fit the neck portion 132. Therefore, the sinking elements 230 can string at equal intervals.

Preferably, the shape of the terminal portion 133 can be spherical, so when the sinking element 230 rotates, the terminal portion 133 will not separate from the corresponding hollow snap fastening member 142. Besides, the radial cross-sectional size D3 of the terminal portion 133 is particularly less than the radial cross-sectional size D1 of the main body 231, so that the radial cross-sectional size of hollow snap fastening members 142 will not protrude over the radial cross-sectional size D1 of the main body 131. Therefore, the terminal portion 133 will not easily separate from the hollow snap fastening member 142.

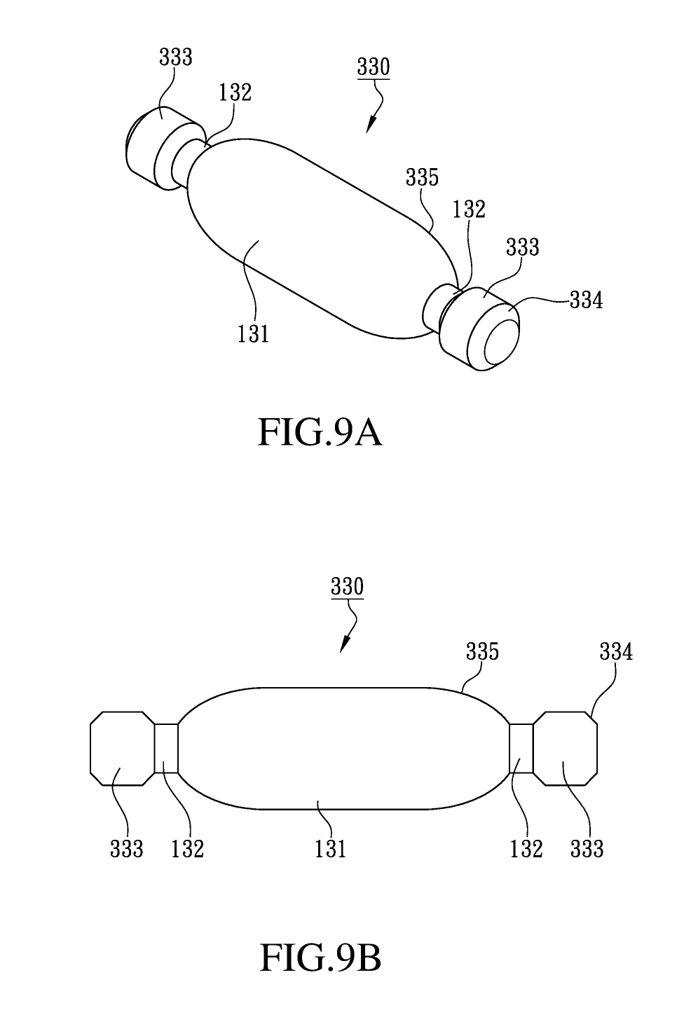

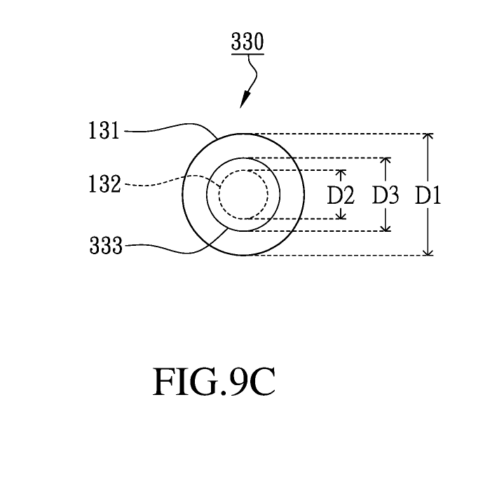

According to a third preferred embodiment of the present invention, a fishing tool sinking rope is provided. Elements with the same name and function corresponding to the one in the first preferred embodiment are labeled with the same reference numbers, and so common features are not described again. A fishing tool sinking rope comprises a module stringing core and a covering woven rope. The covering woven rope is interlaced to cover the module stringing core. The module stringing core is configured to string a plurality of sinking elements 330 at equal intervals. With reference to 9A, 9B and 9C, exploded view, cross-sectional side view and front view of the sinking element 330 are depicted. Each of the sinking elements 330 comprises a main body 131 having two ends connected jointly to a neck portion 132 and a terminal portion 333. The neck portion 132 has a radial cross-sectional size D2 less than a radial cross-sectional size D1 of the main body 131 and a radial cross-sectional size D3 of the terminal portion 333 (shown in the FIG. 9C). The modular snap fastener 140 in the first preferred embodiment can be used to fit the neck portions 132 of the sinking elements 330, and is semi-covered to cover the terminal portions 333 of the sinking elements 330. In this preferred embodiment, the shape of the terminal portion 333 is non-spherical, such as a circle with thickness at least less than half the diameter, a cylinder with length near the diameter, a cone with length not larger than the diameter or a combination thereof, and a plurality of faceted edges 334 are formed around the terminal portion 333, so that the terminal portion 333 will not have the edge of a right or acute angle to reduce the damage of the covering woven rope caused by the terminal portion 333. Preferably, a convergent curved surface 335 formed between the main body 131 of the sinking element 330 and the neck portion 132 helps reduce the damage and deviation of the covering woven rope caused by the main body 131 of the sinking element 330. The convergent curved surface 335 can help increase the volume of the sinking element 330.

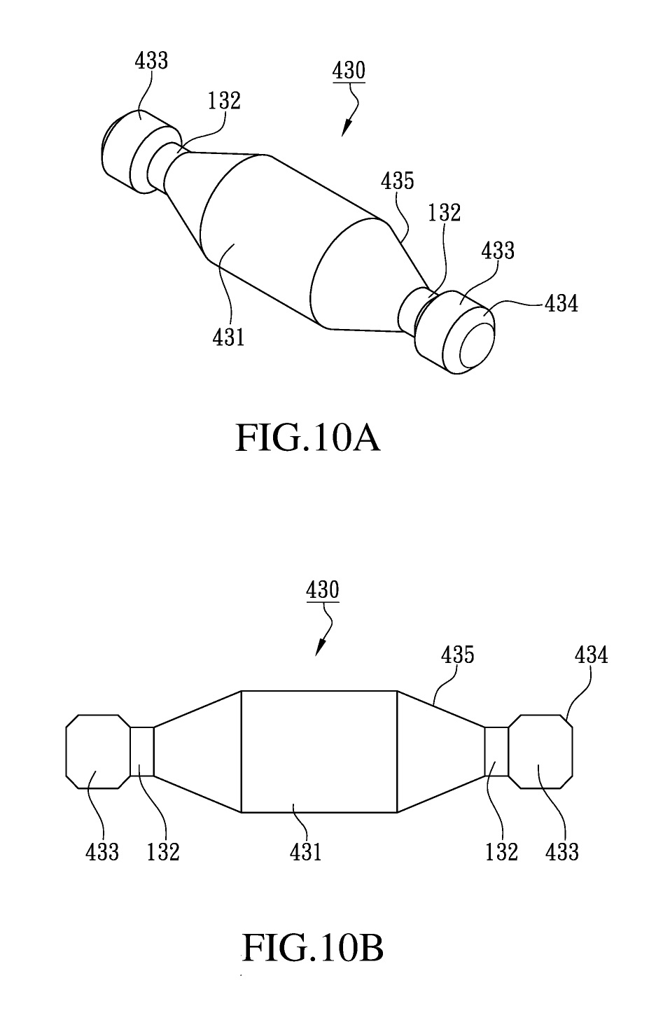

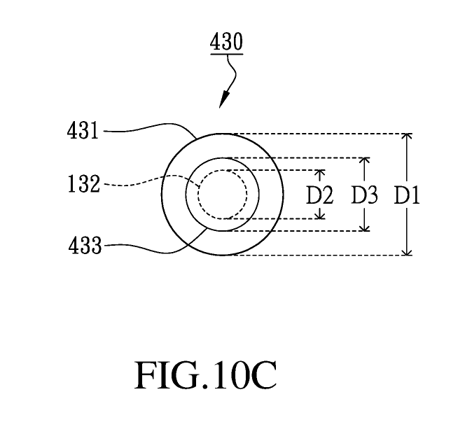

According to a fourth preferred embodiment of the present invention, a fishing tool sinking rope is provided, comprising a module stringing core and a covering woven rope. The covering woven rope is interlaced to cover the module stringing core. The module stringing core is configured to string a plurality of sinking elements 430 at equal intervals. With reference to 10A, 10B and 10C, exploded view, cross-sectional side view and front view of the sinking element 430 are depicted. Each of the sinking elements 430 comprises a main body 131 having two ends connected jointly to a neck portion 132 and a terminal portion 433. The neck portion 132 has a radial cross-sectional size D2 less than a radial cross-sectional size D1 of the main body 131 and a radial cross-sectional size D3 of the terminal portion 433 (shown in the FIG. 10C). The modular snap fastener 140 in the first preferred embodiment can be used to fit the neck portions 132 of the sinking elements 430, and is semi-covered to cover the terminal portions 433 of the sinking elements 430. In this preferred embodiment, the shape of the terminal portion 433 is non-spherical, such as a cylinder with length near the diameter, and a plurality of faceted edges 434 are formed around the terminal portion 433, so that the terminal portion 433 will not have the edge of a right or acute angle to reduce the damage of the covering woven rope caused by the terminal portion 433. Preferably, a convergent tapered surface 435 formed between the main body 131 of the sinking elements 430 and the neck portion 132 helps reduce the damage and deviation of the covering woven rope caused by the main body 131 of the sinking element 430. The convergent tapered surface 435 can help covering woven rope 120 for its covering operation

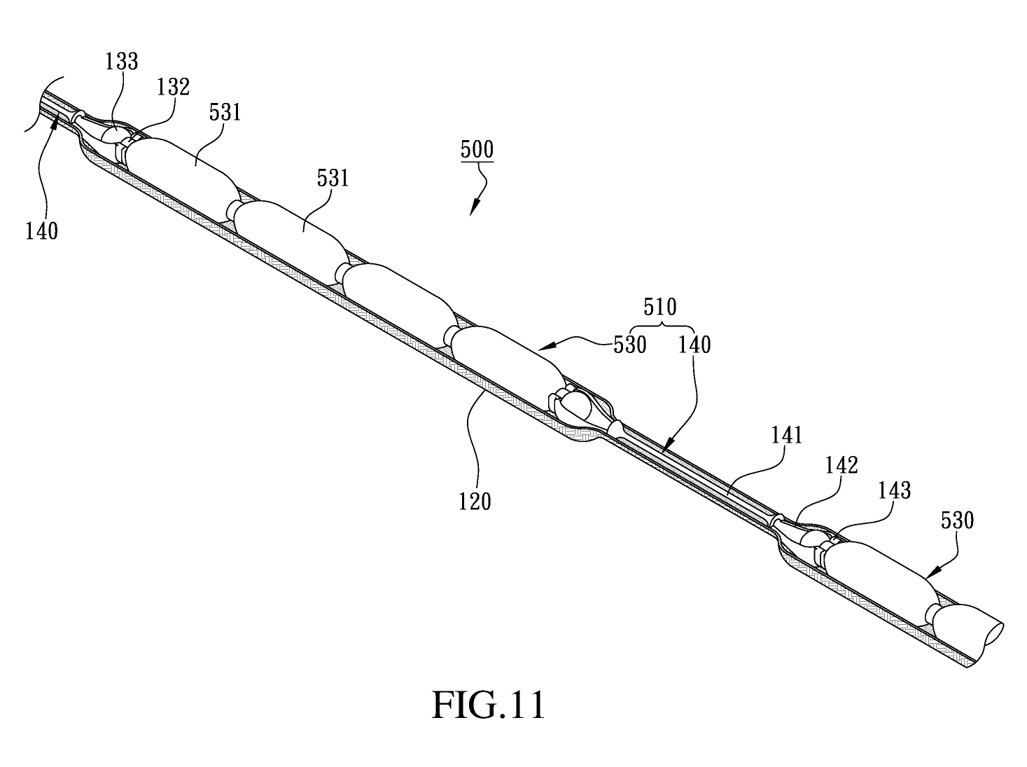

With reference to FIG. 11, a partial exploded view depicting that a fishing tool sinking rope axially cuts the covering woven rope in a fifth preferred embodiment according to the present invention is depicted. Elements with the same name and function corresponding to the one in the first preferred embodiment are labeled with the same reference numbers, and so common features are not described again. A fishing tool sinking rope 500 comprises a module stringing core 510 and a covering woven rope 120. The covering woven rope 120 is interlaced to cover the module stringing core 510.

The module stringing core 510 is configured to string a plurality of sinking elements 530 at equal intervals. Each of the sinking elements 530 has a main body 531 having two ends connected jointly to a neck portion 132 and a terminal portion 133. The neck portion 132 has a radial cross-sectional size less than radial cross-sectional sizes of the main body 531 and the terminal portion 133. The module stringing core 510 further comprises a plurality of modular snap fasteners 140, and each modular snap fastener 140 comprises a bendable line 141 and a plurality of hollow snap fastening members 142 connected to two ends of the bendable line 141 for housing the terminal portions 133. Each of the hollow snap fastening members 142 is comparatively distant from the center of corresponding modular snap fasteners 140 and has a U-shaped gap snap fastening slot 143 configured to fit the neck portion 132. Preferably, at least a plurality of main bodies can be a counterweight chain, namely the main body 531 is strung by a plurality of smaller sinking element blocks, and a plurality of the main bodies 531 of sinking elements 530 can bend or extend the counterweight length of the sinking rope, so that the goal of adjusting the counterweight section of sinking rope can be achieved. The stringing relationship between sinking element blocks and the connection between the main body 531 and the adjacent terminal portions 133 can be classified as connected jointly, line knotting after forming, center line stringing after forming, or mold, hook or snap placed inside the center line while foaming. More particularly, the unit interval between the sinking element blocks is less than the unit length of the bendable line 141.

The foregoing detailed description is merely in relation to a preferred embodiment and shall not be construed as limiting the invention. It is to be understood that many other possible modifications and variations can be made without departing from the spirit and scope of the invention as hereinafter claimed.

1-16. (canceled)

17. A fishing tool sinking rope, comprising:
a module stringing core configured to string a plurality of sinking elements at equal intervals, each of the sinking elements has a main body having two ends connected jointly to a neck portion and a terminal portion, wherein the neck portion has a radial cross-sectional size less than radial cross-sectional sizes of the main body and the terminal portion, the module stringing core further comprising a plurality of modular snap fasteners, each modular snap fastener including a bendable line and a plurality of droplet-shaped hollow snap fastening members connected to two ends of the bendable line for housing a plurality of terminal portions, each of the hollow snap fastening members being comparatively distant from the center of corresponding modular snap fasteners and has a U-shaped gap snap fastening slot configured to fit the neck portion; and
a covering woven rope interlaced to cover the module stringing core.

18. The fishing tool sinking rope as claimed in claim 17, wherein the hollow snap fastening member is semi-covered, and protrusions on the two sides of the U-shaped gap snap fastening slot are flexible for clamping.

19. The fishing tool sinking rope as claimed in claim 18, wherein the shape of the terminal portion is spherical.

20. The fishing tool sinking rope as claimed in claim 19, wherein the radial cross-sectional size of the terminal portion is less than the radial cross-sectional size of the main body, so that the radial cross-sectional size of hollow snap fastening members will not protrude over the radial cross-sectional size of the main body.

21. The fishing tool sinking rope as claimed in claim 18, wherein the cross section of the hollow snap fastening members is semi-cut and is a tapered edge leaning toward the opening of the U-shaped gap snap fastening slot.

22. The fishing tool sinking rope as claimed in claim 17, wherein the shape of the main body is cylindrical.

23. The fishing tool sinking rope as claimed in claim 18, wherein the shape of the main body is cylindrical.

24. The fishing tool sinking rope as claimed in claim 19, wherein the shape of the main body is cylindrical.

25. The fishing tool sinking rope as claimed in claim 20, wherein the shape of the main body is cylindrical.

26. The fishing tool sinking rope as claimed in claim 21, wherein the shape of the main body is cylindrical.

27. The fishing tool sinking rope as claimed in claim 17, wherein the shape of the main body is oval.

28. The fishing tool sinking rope as claimed in claim 18, wherein the shape of the main body is oval.

29. The fishing tool sinking rope as claimed in claim 19, wherein the shape of the main body is oval.

30. The fishing tool sinking rope as claimed in claim 20, wherein the shape of the main body is oval.

31. The fishing tool sinking rope as claimed in claim 21, wherein the shape of the main body is oval.

32. The fishing tool sinking rope as claimed in claim 17, wherein at least a main body is a counterweight chain.

33. The fishing tool sinking rope as claimed in claim 18, wherein at least a main body is a counterweight chain.

34. The fishing tool sinking rope as claimed in claim 19, wherein at least a main body is a counterweight chain.

35. The fishing tool sinking rope as claimed in claim 20, wherein at least a main body is a counterweight chain.

36. The fishing tool sinking rope as claimed in claim 21, wherein at least a main body is a counterweight chain.

37. A modular snap fastener, configured to string a plurality of sinking elements at equal intervals, each of the sinking elements has a main body having two ends connected jointly to a neck portion and a terminal portion, wherein the neck portion has a radial cross-sectional size less than the radial cross-sectional sizes of the main body and the terminal portion, the modular snap fastener comprising:
a bendable line; and
a plurality of droplet-shaped hollow snap fastening members connected to two ends of the bendable line for housing a plurality of terminal portions, each of the hollow snap fastening members being comparatively distant from the center of corresponding modular snap fasteners and has a U-shaped gap snap fastening slot configured to fit the neck portion.

38. The modular snap fastener as claimed in claim 37, wherein the hollow snap fastening member is semi-covered, and protrusions on the two sides of the U-shaped gap snap fastening slot are flexible for clamping.

39. The modular snap fastener as claimed in claim 38, wherein the cross section of the hollow snap fastening members is semi-cut and is a tapered edge leaning toward the opening of the U-shaped gap snap fastening slot.

40. A fishing tool sinking rope, comprising:
a module stringing core configured to string a plurality of sinking elements at equal intervals, each of the sinking elements having a main body having two ends connected jointly to a neck portion and a terminal portion, wherein the neck portion has a radial cross-sectional size less than the radial cross-sectional sizes of the main body and the terminal portion, the module stringing core further comprising a plurality of modular snap fasteners, each modular snap fastener comprising a bendable line and a plurality of hollow snap fastening members connected to two ends of the bendable line for housing the terminal portions, and each of the hollow snap fastening members is comparatively distant from the center of corresponding modular snap fasteners and having a U-shaped gap snap fastening slot configured to fit the neck portion.; and
a covering woven rope interlaced to cover the module stringing core.

41. The fishing tool sinking rope as claimed in claim 40, wherein the shape of the terminal portion is not non-spherical, and a plurality of faceted edges are formed around the terminal portions.

42. The fishing tool sinking rope as claimed in claim 40, wherein a convergent curved surface is formed between the main body and the neck portion

43. The fishing tool sinking rope as claimed in claim 40, wherein a convergent tapered surface is formed between the main body and the neck portion

44. The fishing tool sinking rope as claimed in claim 40, wherein at least a main body is a counterweight chain.

45. The fishing tool sinking rope as claimed in claim 41, wherein at least a main body is a counterweight chain.

46. The fishing tool sinking rope as claimed in claim 42, wherein at least a main body is a counterweight chain.

47. The fishing tool sinking rope as claimed in claim 43, wherein at least a main body is a counterweight chain.
